(19) United States
(12) Patent Application Publication
(10) Pub. No.: US 2008/0316784 A1
(43) Pub. Date: Dec. 25, 2008

(54) ISOLATED RADIATION HARDENED ELECTRONICS ON/OFF CONTROL CIRCUIT

(76) Inventor: GEORGE L. CEBRY, Glendale, AZ (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/766,914

(22) Filed: Jun. 22, 2007

(51) Int. Cl. H02M 7/06

(52) U.S. Cl. 363/126

(57) ABSTRACT

An isolated ground on/off control circuit includes a first transformer amplifying an AC input voltage, a second transformer connected in parallel to the first transformer; and output circuitry that rectifies the AC input voltage to an isolated DC output voltage. The on/off control circuit may provide improved redundant operation by utilizing a first and a second transformer in parallel and dual diodes for rectification. An on/off command transformer may be designed to have the smallest manufacturable package size and to meet aerospace requirements. The on/off control circuit and method for providing an isolated on/off command to an electronic device as in one embodiment of the present invention may be suitable for, but not limited to, applications in the aircraft and aerospace industries, such as applications in electronic equipments of spacecraft.

### BACKGROUND OF THE INVENTION

The present invention generally relates to electronic circuits and devices and, more particularly, to an isolated ground on/off control circuit and a method for providing an isolated on/off command to an electronic device used in aerospace applications.

Most currently developed electronic devices include some form of isolated ground on/off control. The on/off control is typically used to enable and disable such electronic devices. In the disabled mode also known as standby mode, electronic devices are powered off to reduce power consumption.

Prior art on/off control circuits include, for example, the isolated ground on/off circuit 10 as shown in FIG. 1. When a DC (direct current) input voltage 11 is applied to the on/off circuit 10, the opto-coupler 12 creates an isolated DC output voltage 13 that is used as an on/off command to an electronic device. Problems with prior art on/off control circuits, such as circuit 10, are that they have a relatively high power consumption. For example, at least +5V (volts) at 5 mA (milliamperes) are needed as input voltage 11 for the opto-coupler to be turned on. Therefore, the opto-coupler 12 used in the prior art on/off circuit 10 is not compatible with technologies that require operation of an on/off control circuit at voltages below 5 V, for example, at 3.3 V, 2.5 V, 1.8 V, 1.2 V, and 1.0 V. An input voltage 11 at 3.3 V or below on the line driver of the opto-coupler 12 is too low to turn the LED (light-emitting diode) 14 on.

Furthermore, semiconductor devices, such as the opto-coupler 12 are prone to degradation with high doses of radiation. Devices, such as opto-coupler 12, have a relative low radiation tolerance of about 150 kRads (kilo radiation absorbed doses). The performance of prior art devices, such as the opto-coupler 12, degrades with prolonged exposure to radiation until failure occurs. Such behavior is not desirable for aerospace applications.

Therefore, a second opto-coupler 15 is often used in prior art on/off circuits such as circuit 10. While a second opto-coupler 15 may provide some back up operation for the opto-coupler 12, a short 16 on the secondary side 17 of the opto-coupler 12 would prevent operation of both devices, opto-coupler 12 and opto-coupler 15.

As can be seen, there is a need for an isolated ground on/off circuit that has lower input voltage operation, reduced power consumption, improved radiation operation and improved redundant operation. Furthermore, there is a need for replacing a prior art opto-coupler with an electronic device that provides ground isolation, that does not take up more space on a printed circuit board than a prior art opto-coupler, and that meets the requirements of space agencies.

### SUMMARY OF THE INVENTION

In one aspect of the present invention, an isolated ground on/off control circuit comprises a first transformer amplifying an AC input voltage, a second transformer connected in parallel to the first transformer, and output circuitry connected to the first and the second transformer. The output circuitry rectifies the AC input voltage to an isolated DC output voltage.

In another aspect of the present invention, an on/off command transformer comprises a header including four terminals, and a core mounted to the header standing up.

In a further aspect of the present invention, a method for providing an isolated on/off command to an electronic device comprises the steps of designing a transformer to have the smallest manufacturable package size and to meet aerospace requirements, integrating the transformer into an isolated ground on/off control circuit, and backing up operation of the transformer by connecting an additional transformer in parallel to the transformer.

These and other features, aspects and advantages of the present invention will become better understood with reference to the following drawings, description and claims.

### BRIEF DESCRIPTION OF THE DRAWINGS

FIG. 1 is a block diagram schematically representing a prior art isolated ground on/off circuit;

FIG. 2 is a block diagram schematically representing an isolated ground on/off control circuit according to an embodiment of the present invention;

FIG. 3a is a top view of an on/off command transformer according to an embodiment of the present invention;

FIG. 3b is a side view of an on/off command transformer according to an embodiment of the present invention; and

FIG. 4 is a flow chart schematically representing a method for providing an isolated on/off command to an electronic device according to an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides an on/off circuit that utilizes a transformer for ground isolation and a method for providing an isolated on/off command to an electronic device. The on/off control circuit and method as in one embodiment of the present invention may be suitable for, but not limited to, applications in the aircraft and aerospace industries, such as applications in electronic equipments of spacecraft. The on/off control circuit as in one embodiment of the present invention may be used, for example, for spacecraft computers.

In contrast to prior art on/off control circuits, where an opto-coupler is used to provide an isolated DC voltage command to an electronic device, the on/off control circuit as in one embodiment of the present invention utilizes a specifically designed transformer. The transformer as in one embodiment of the present invention may be operated at lower voltages than a prior art opto-coupler, since a transformer can step-up an input voltage. Thus, by using the transformer for ground isolation, less power is used compared to a prior art opto-coupler.

Furthermore, contrary to an opto-coupler that is a semiconductor device and, therefore, is prone to degradation with relative high doses of radiation, the transformer as in one embodiment of the present invention is not susceptible to radiation. Since relative high doses of radiation are found in outer space, the transformer as in one embodiment of the present invention may be better suited for aerospace applications than the prior art opto-coupler.

In still further contrast with the prior art, where a second opto-coupler in parallel to a first opto-coupler may not provide redundant operation, for example in case of a short on the output of the first opto-coupler, the on/off control circuit as in one embodiment of the present invention may provide improved redundant operation by utilizing a first and a second transformer in parallel and dual diodes for rectification. A short on the output of the first transformer will not impair redundant operation of the on/off control circuit as in one embodiment of the present invention.

Still further, the present invention as in one embodiment provides a high frequency transformer specifically designed for aerospace applications. By using only four terminals and by mounting a core standing up to a header, the smallest manufacturable package size of the transformer may be achieved. The transformer as in one embodiment of the present invention may take up less space on a printed circuit board than a prior art opto-coupler.

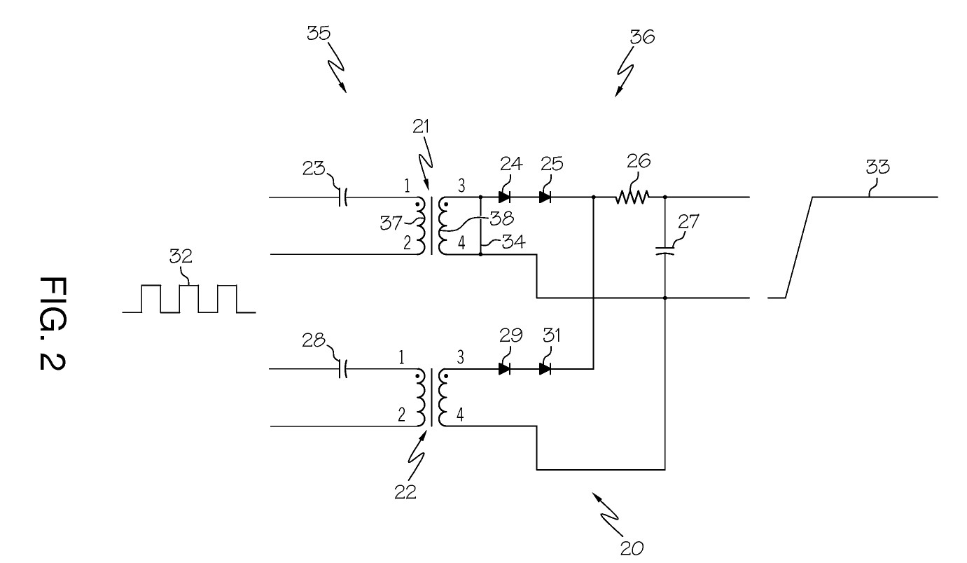

Referring now to FIG. 2, a block diagram schematically representing an isolated ground on/off control circuit 20 is illustrated according to an embodiment of the present invention. The on/off control circuit 20 may include a first transformer 21 and a second transformer 22. The second transformer 22 may be connected in parallel to the first transformer 21 and may back up the operation of the first transformer 21. A DC blocking capacitor 23 may be included in the input circuitry 35 of the first transformer 21. A first diode 24, a second diode 25, a resistor 26, and a capacitor 27 may be included in the output circuitry 36 of the first transformer 21. A DC blocking capacitor 28 may be included in the input circuitry 35 of the second transformer 22. A first diode 29, a second diode 31, the resistor 26, and the capacitor 27 may be included in the output circuitry 36 of the second transformer 22.

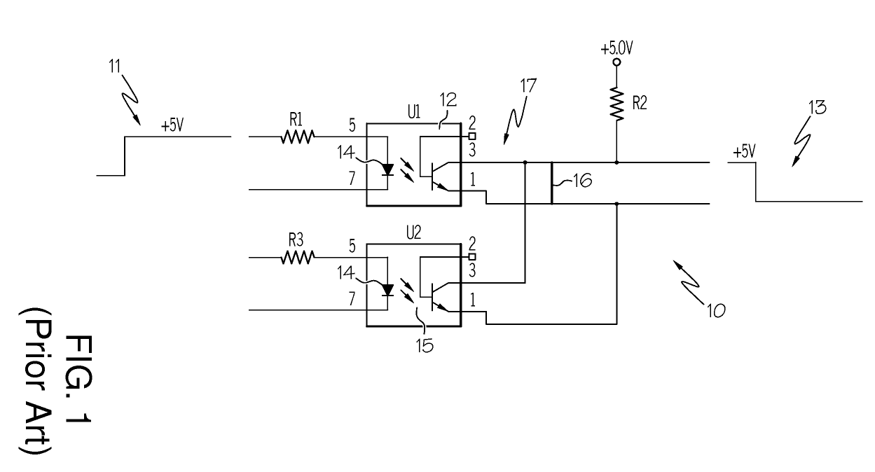

When an AC (alternating current) input voltage 32 is applied to the on/off control circuit 20 and, therefore to the first or the second transformer 21 or 22, respectively, the AC input voltage 32 may be amplified by the first transformer 21 or the second transformer 22 and may then be rectified by the output circuitry 36 to create an isolated DC (direct current) output voltage 33, which may be used as an isolated DC voltage on/off command to an electronic device. The output voltage 33 may be an isolated DC voltage since the input 35 and the output 36 of the transformer 21 or 22 may not have a common ground. The capacitors 23 and 28 in the input circuitry 35 of the first transformer 21 and the second transformer 22, respectively, may prevent any DC voltage getting into the transformer 21 and 22, respectively. The output circuitry 36 of the first transformer 21 (diodes 24 and 25, resistor 26, capacitor 27) as well as the output circuitry 36 of the second transformer 22 (diodes 29 and 31, resistor 26, capacitor 27) may convert the amplified AC input voltage 32 into the DC output voltage 33. Since the transformers 21 and 22 may be used to step up the input voltage 32, it is possible to operate the circuit 20 at lower input voltages than prior art on/off control circuits (for example, prior art circuit 10, FIG. 1), for example at input voltages 32 at or below about 3.3 V. Furthermore, by operating at lower input voltages 32, the on/off control circuit 20 as in one embodiment of the present invention may interface with digital logic technologies that may drive circuit 20 at voltages below 5 V. Also, the power consumed by the power supply driving the transformer 21 or 22 may be reduced. For example, a 100 kHz drive current of about 1.8 mA (milliamperes) would be sufficient to drive transformer 21 or 22 at, for example, about 3.3 V input voltage 32.

By including the first transformer 21 and the second transformer 22 in the on/off control circuit 20, redundant operation of the circuit 20 is provided. For example, a short 34 on secondary side 38 of the first transformer 21 may not prevent operation of the second transformer 22 and, therefore, may not degrade performance of redundant operation of the circuit 20. Furthermore, providing dual diodes (diodes 24 and 25 in the output circuitry 36 of the first transformer 21; diodes 29 and 31 in the output circuitry 36 of the second transformer 22) for rectification may provide redundancy by allowing normal operation of the circuit 20 in case one of the diodes 24 and 25 or 29 and 31 shorts. While the on/off control circuit 20 is shown in FIG. 2 to provide redundancy, it may operate with only the first transformer 21 and the diode 24.

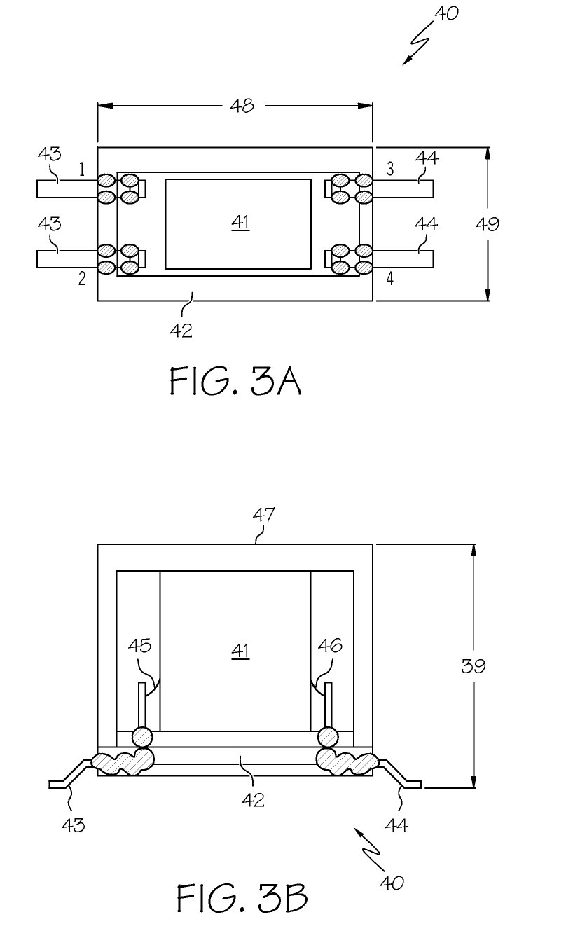

Referring now to FIGS. 3a and 3b, a top view and side view of an on/off command transformer 40 are illustrated, respectively, according to an embodiment of the present invention. Transformer 40 may be used in the on/off control circuit 20 as the first transformer 21 and as the second transformer 22. Transformer 40 may include a core 41 mounted to a header 42, and two input terminals 43 and two output terminals 44. A housing 47 filled with transformer potting material may accommodate the core 41.

The core 41 may be a relatively small sized commercially available core type, for example, YW-40603-TC manufactured by Magnetics, Pennsylvania, U.S.A. The core 41 may be mounted to the header standing up. Wires 45 and 46 (shown in FIG. 3b) are wound around the core 41. The wires 45 and 46 have a certain wire gage, for example, wire gage 36. The primary side 37 of the transformer 40 may include a certain number of turns of the wire 45, for example 25, and the secondary side 38 of the transformer 40 may include a certain number of turns of the wire 46, for example 75. The input voltage 32 (FIG. 2) may be stepped up or down by adjusting the number of secondary turns to the number of primary turns on transformer 40. As can be seen in FIG. 3b, the wires 45 may connect from the core 41 to the input terminals 43 and the wires 46 may connect from the core 41 to the output terminals 44. The primary windings (wires 45) and the secondary windings (wires 46) may be wound around the core 41 in a bifilar fashion to obtain the lowest possible leakage inductance. In order to achieve the lowest possible leakage inductance, four wire strands (45, 46) may be twisted and wound around the core 41 for 25 turns. Each of the four wire strands 45 and 46 may have a gage of about 36. One strand 45 of the four wire strands may be separated and connected to the primary side 37 of the transformer 40 and the remaining three wire strands 46 of the four wire strands may be connected in series and to the secondary side 38 of the transformer 40.

The potted size of the transformer, where the core 41 is mounted to the header 42 may have a package design to achieve a relatively small size to take up as little space as possible on a printed circuit board. For example, the width 48 of the header 42 may be about 0.40″ (inches) and the depth 49 of the header 43 may be about 0.20″, as shown in FIG. 3a. The height 39 of the potted transformer 40 may be about 0.35″, as shown in FIG. 3b. The transformer 40 may be a high frequency transformer operating, for example, at frequencies of about 100 kHz (kilohertz). The transformer 40 is not susceptible to total dose radiation and, therefore, will withstand a total dose radiation of at least about 1000 kRad. The transformer 40 may be designed to meet requirements of space agencies, for example, standard MIL-STD-981, and may, therefore, be suitable for aerospace applications.

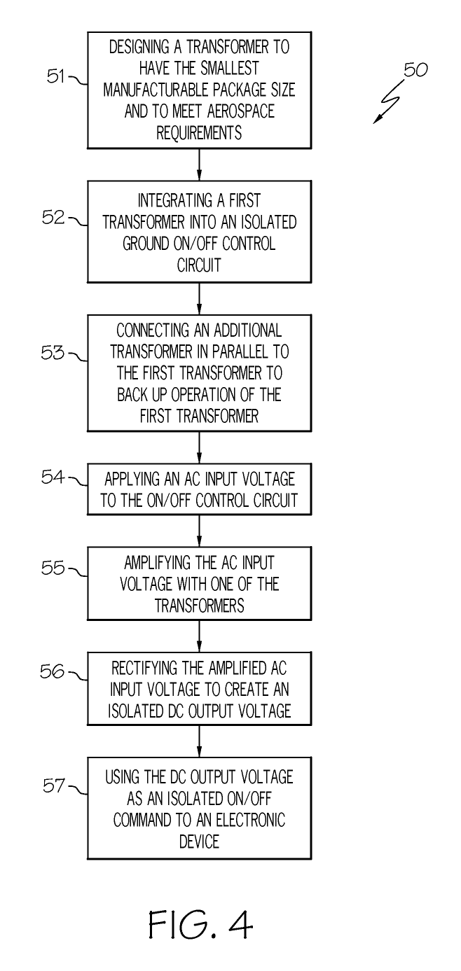

Referring now to FIG. 4, a flow chart schematically representing a method 50 for providing an isolated on/off command to an electronic device is illustrated according to an embodiment of the present invention. Method 50 may involve a step 51 where a transformer 40 (FIGS. 3a and 3b) is designed to meet aerospace requirements and to have the smallest manufacturable package size. In a step 52, the transformer 40 (first transformer 21 shown in FIG. 2) may be integrated into the isolated ground on/off control circuit 20 (FIG. 2). An additional transformer 40 (second transformer 22 shown in FIG. 2) may be connected in parallel to the first transformer 21 to back up operation of the first transformer 21 in a following step 53.

A step 54 may involve applying an AC input voltage 32 to the on/off control circuit 20. The AC input voltage 32 may be amplified with the first transformer 21 or the second transformer 22 in a step 55. In a step 56, the now amplified AC input voltage 32 may be rectified to create an isolated DC output voltage 33. The isolated DC output voltage 33 may be used as an isolated on/off command to an electronic device in step 57.

It should be understood, of course, that the foregoing relates to exemplary embodiments of the invention and that modifications may be made without departing from the spirit and scope of the invention as set forth in the following claims.

We Claim:

1. An isolated ground on/off control circuit, comprising:
a first transformer amplifying an AC input voltage;
a second transformer connected in parallel to said first transformer; and
output circuitry connected to said first and said second transformer, wherein said output circuitry rectifies said AC input voltage to an isolated DC output voltage.

2. The on/off control circuit of claim 1, wherein said output circuitry includes a diode, a resistor, and a capacitor.

3. The on/off control circuit of claim 1, wherein said output circuitry includes dual diodes.

4. The on/off control circuit of claim 1, further comprising input circuitry for said first and said second transformer, wherein said input circuitry includes a capacitor.

5. The on/off control circuit of claim 1, wherein said second transformer backs up the operation of said first transformer.

6. The on/off control circuit of claim 1, wherein said AC input voltage is at or below about 3.3 V.

7. The on/off control circuit of claim 1, wherein said DC output voltage provides an isolated on/off command to an electronic device.

8. The on/off control circuit of claim 1, wherein a drive current of about 1.8 mA drives said first or said second transformer.

9. The on/off control circuit of claim 1, wherein said first and said second transformer is a high frequency transformer operation at frequencies of about 100 kHz.

10. The on/off control circuit of claim 1, wherein said first and said second transformer withstands total dose radiation of at least about 1000 krad.

11. An on/off command transformer, comprising:
a header including four terminals; and
a core mounted to said header standing up.

12. The transformer of claim 11, wherein said header has a width of about 0.40″ and a depth of about 0.20″.

13. The transformer of claim 11, wherein said transformer has a height of about 0.35″ when potted.

14. The transformer of claim 11, further including four wire strands twisted and wound around said core, wherein one of said four wire strands is separated and connected to the primary side of said transformer, and wherein the remaining three wire strands of said four wire strands are connected in series and to the secondary side of said transformer.

15. The transformer of claim 14, wherein each of said four wire strands has a gage of about 36, and wherein said four wire strands are wound around said core for 25 turns.

16. The transformer of claim 11, wherein said transformer meets aerospace application standards.

17. A method for providing an isolated on/off command to an electronic device, comprising the steps of:
designing a transformer to meet aerospace requirements;
integrating said transformer into an isolated ground on/off control circuit; and
backing up operation of said transformer by connecting an additional transformer in parallel to said transformer.

18. The method of claim 17, further including the steps of:
applying an AC input voltage to said on/off control circuit;
amplifying said AC input voltage with one of said transformers; and
creating an isolated DC output voltage by rectifying said AC input voltage.

19. The method of claim 17, further including the steps of:
operating said on/off control circuit at an AC input voltage lower than about 5 V; and
using said isolated DC output voltage as an isolated on/off command to an electronic device.

20. The method of claim 17, further including the steps of:
integrating dual diodes for rectification of said AC input voltage; and
enabling redundant operation of said on/off control circuit.
